(19) United States
(12) Patent Application Publication
(10) Pub. No.: US 2015/0307343 A1
(43) Pub. Date: Oct. 29, 2015

(54) Equine Side Protective Device

(71) Applicant: Christine Daly, Brookings, SD (US)

(72) Inventor: Christine Daly, Brookings, SD (US)

(21) Appl. No.: 14/259,409

(22) Filed: Apr. 23, 2014

(51) Int. Cl. B68C 5/00

(52) U.S. Cl. CPC B68C 5/00

(57) ABSTRACT

An equine side protective device covers and protects the sides of an equine from rubbing by legs or spurs during horse riding activities. The device includes a band having a first end, a second end, and a pair of longitudinal sides extending between the first end and the second end. A fastener is coupled to the band adjacent to the first end. The fastener is engageable to the band as the band is extended around an equine securing the band around a back, barrel, and flanks of the equine. A loop is coupled to the band and positioned on a side of the band wherein the loop receives therethrough a strap securing a saddle to the equine.

### BACKGROUND OF THE DISCLOSURE

### Field of the Disclosure

The disclosure relates to protective devices and more particularly pertains to a new protective device for covering and protecting the sides of an equine from rubbing by legs or spurs during horse riding activities.

### SUMMARY OF THE DISCLOSURE

An embodiment of the disclosure meets the needs presented above by generally comprising a band having a first end, a second end, and a pair of longitudinal sides extending between the first end and the second end. A fastener is coupled to the band adjacent to the first end. The fastener is engageable to the band as the band is extended around an equine securing the band around a back, barrel, and flanks of the equine. A loop is coupled to the band and positioned on a side of the band wherein the loop receives therethrough a strap securing a saddle to the equine.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side view of an equine side protective device according to an embodiment of the disclosure.

FIG. 2 is a top view of an embodiment of the disclosure in an open position.

FIG. 3 is a bottom view of an embodiment of the disclosure in an open position.

FIG. 4 is a side view of an embodiment of the disclosure in use.

### DESCRIPTION OF THE PREFERRED EMBODIMENT

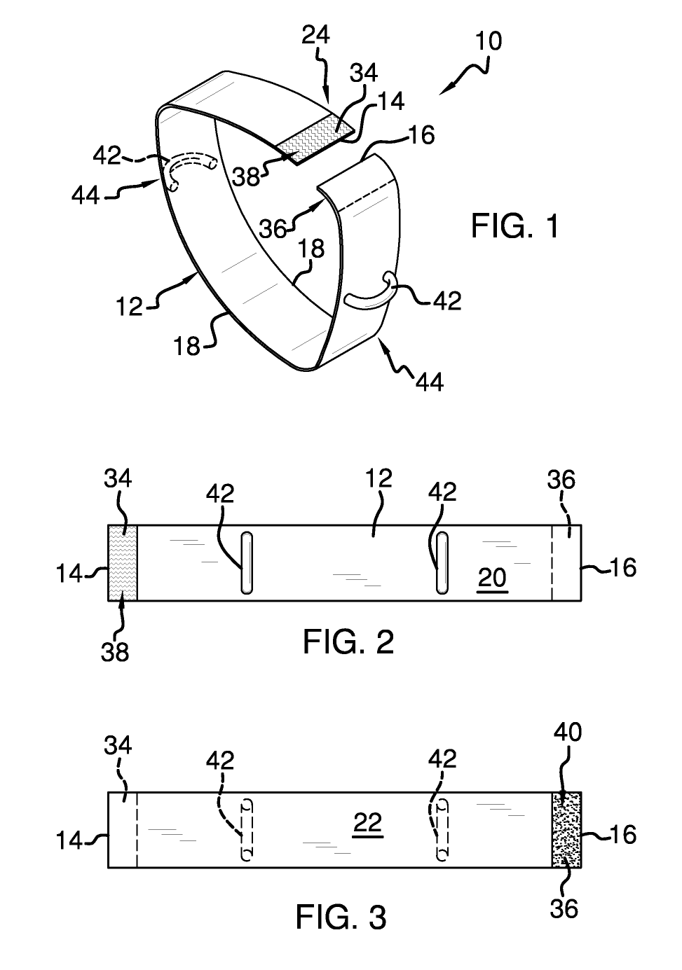

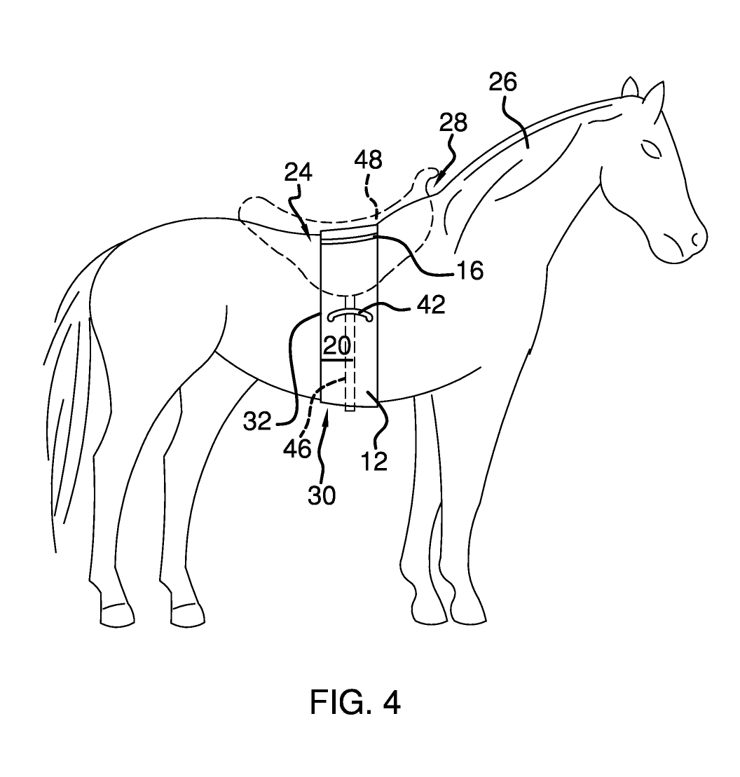

With reference now to the drawings, and in particular to FIGS. 1 through 6 thereof, a new protective device embodying the principles and concepts of an embodiment of the disclosure and generally designated by the reference numeral 10 will be described.

As best illustrated in FIGS. 1 through 6, the equine side protective device 10 generally comprises a band 12 having a first end 14, a second end 16, and a pair of longitudinal sides 18 extending between the first end 14 and the second end 16. The band 12 has a first face 20 and a second face 22. A fastener 24 is coupled to the band 12. The fastener 24 is positioned adjacent to the first end 14 of the band 12 and engageable to the band 12 such that the band 12 is configured for being extended around and secured to an equine 26 such that the band 12 is positioned around a back 28, barrel 30, and flanks 32 of the equine 26. The fastener 24 comprises a first portion 34 of hook and loop fastener coupled to the first face 20 of the band 12 and a second portion 36 of hook and loop fastener coupled to the second face 22 of the band 12. The second portion 36 of hook and loop fastener is complementary to the first portion 34 of hook and loop fastener. Thus, the fastener 24 secures to the equine 26 without twisting or folding to allow for positioning of the fastener 24 on the back 28 of the equine 26. The first portion 34 of hook and loop fastener is hook fastener 38 and the second portion 36 of hook and loop fastener is loop fastener 40 wherein the loop fastener 40 is configured to face the equine 26 when the band 12 is secured to the equine 26. The hook fastener 38 faces away from the equine 26 to prevent irritation and scraping against the back 28 of the equine 26 during use.

Each of a pair of loops 42 is coupled to the band 12. Each of the loops 42 is positioned on a respective side 44 of the band 12 wherein each loop 42 is configured for receiving therethrough a respective strap 46 securing a saddle 48 to the equine 26. Each loop 42 is coupled to the first face 20 of the band 12 to face outwardly from the equine 26. The strap 46 extending through the loop 42 may be part of a girth, as in Australian or English saddles, or cinch, as commonly found in western saddles. Thus, the device 10 may be used with both types of saddles. The band 12 is constructed of a durable material conventionally known to resist wear and inhibit transference of friction on the first face 20 of the band 12 to the equine 26 through the band 12. The band 12 is further constructed of a conventionally known flexible material wherein the band 12 transmits pressure placed on the first face 20 of the band 12 to the equine 26 through the band 12 such that the equine 26 is protected but remains responsive to sensory input delivered by a foot of a rider while riding.

In use, the band 12 is secured to the equine 26 and the saddle 48 is secured to the equine 26 over the band 12. The equine 26 is then ridden in normal fashion while the device 10 protects the flanks 32 as the equine 26 is ridden.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An equine side protective device comprising:
a band having a first end, a second end, and a pair of longitudinal sides extending between said first end and said second end;
a fastener coupled to said band, said fastener being positioned adjacent to said first end of said band and engageable to said band such that said band is configured for being extended around and secured to an equine such that said band is positioned around a back, barrel, and flanks of the equine; and
a loop, said loop being coupled to said band, said loop being positioned on a side of said band wherein said loop is configured for receiving therethrough a strap securing a saddle to the equine.

2. The device of claim 1, further comprising said loop being one of a pair of said loops, each of said loops being coupled to said band, each of said loops being positioned on a respective side of said band wherein each said loop is configured for receiving therethrough a respective strap securing the saddle to the equine.

3. The device of claim 2, further comprising said band having a first face and a second face, each said loop being coupled to said first face of said band.

4. The device of claim 1, further comprising said fastener comprising a first portion of hook and loop fastener coupled to said first face of said band and a second portion of hook and loop fastener coupled to said second face of said band, said second portion of hook and loop fastener being complementary to said first portion of hook and loop fastener.

5. The device of claim 4, further comprising said first portion of hook and loop fastener being hook fastener and said second portion of hook and loop fastener being loop fastener wherein said loop fastener is configured to face the equine when said band is secured to the equine.

6. The device of claim 1, further comprising said band being constructed of a durable material wherein said band is configured for inhibiting transference of friction on a first face of said band to the equine through said band.

7. The device of claim 6, further comprising said band being constructed of a flexible material wherein said band is configured for transmitting pressure placed on said first face of said band to the equine through said band.

8. An equine side protective device comprising:
a band having a first end, a second end, and a pair of longitudinal sides extending between said first end and said second end, said band having a first face and a second face;
a fastener coupled to said band, said fastener being positioned adjacent to said first end of said band and engageable to said band such that said band is configured for being extended around and secured to an equine such that said band is positioned around a back, barrel, and flanks of the equine, said fastener comprising a first portion of hook and loop fastener coupled to said first face of said band and a second portion of hook and loop fastener coupled to said second face of said band, said second portion of hook and loop fastener being complementary to said first portion of hook and loop fastener, said first portion of hook and loop fastener being hook fastener and said second portion of hook and loop fastener being loop fastener wherein said loop fastener is configured to face the equine when said band is secured to the equine;
a pair of loops, each of said loops being coupled to said band, each of said loops being positioned on a respective side of said band wherein each said loop is configured for receiving therethrough a respective strap securing a saddle to the equine, each said loop being coupled to said first face of said band; and
wherein said band is constructed of a durable material wherein said band is configured for inhibiting transference of friction on a first face of said band to the equine through said band, said band being constructed of a flexible material wherein said band is configured for transmitting pressure placed on said first face of said band to the equine through said band.
